(19) United States
(12) Patent Application Publication
(10) Pub. No.: US 2025/0242626 A1
(43) Pub. Date: Jul. 31, 2025

(54) HEAT-SENSITIVE RECORDING MATERIAL

(71) Applicant: Oji Holdings Corporation, Tokyo (JP)

(72) Inventors: Takashi TAKEMURA, Tokyo (JP); Naonobu SUGIYAMA, Tokyo (JP)

(73) Assignee: Oji Holdings Corporation, Tokyo (JP)

(21) Appl. No.: 18/854,259

(22) PCT Filed: Apr. 6, 2023
(86) PCT No.: PCT/JP2023/014184

§ 371 Date: Oct. 4, 2024

(30) Foreign Application Priority Data
Apr. 7, 2022 (JP) 2022-063773

(51) Int. Cl. B41M 5/46; B41M 5/41; B41M 5/42

(52) U.S. Cl. CPC B41M 5/46; B41M 5/41; B41M 5/42; B41M 2205/04; B41M 2205/32; B41M 2205/36

(57) ABSTRACT

Disclosed is a heat-sensitive recording material comprising at least an undercoat layer and a heat-sensitive recording layer in this order on a support,
the undercoat layer containing an inorganic pigment, hollow particles, and a binder,
the heat-sensitive recording layer containing a leuco dye, developers, and a binder,
the heat-sensitive recording layer containing a first developer and a second developer as the developers,
the heat-sensitive recording layer containing an N,N′-diarylurea-based compound represented by formula (1) as the second developer:

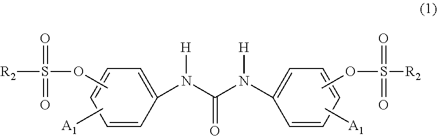

wherein
R₂ represents a C₁₋₁₂ alkyl group, a C₇₋₁₂ aralkyl group, or a C₆₋₁₂ aryl group, the aralkyl group and aryl group may be substituted with a C₁₋₁₂ alkyl group, a C₁₋₁₂ alkoxy group, a C₆₋₁₂ aryl group, or a halogen atom, and a plurality of R₂s may be the same or different; and
A₁ represents a hydrogen atom or a C₁₋₄ alkyl group, and a plurality of A₁s may be the same or different.

### TECHNICAL FIELD

The present invention relates to a heat-sensitive recording material.

### BACKGROUND ART

Heat-sensitive recording materials, which are in wide practical use, record color images by taking advantage of a heat-induced color development reaction between a colorless or pale-colored leuco dye and a phenol or an organic acid. Such heat-sensitive recording materials have advantages in that, for example, color images can be formed simply by the application of heat, and further, recording devices for these can be compact, can be easily maintained, and generate less noise. For this reason, heat-sensitive recording materials have been used in a broad range of technical fields as information-recording materials for printing devices such as label printers, automatic ticket vending machines, CD/ATMs, order form output devices for use in restaurants etc., data output devices in apparatuses for scientific research, etc.

Since such a color development reaction is a reversible reaction, color images are known to fade with time. This color-fading reaction is accelerated in a high-temperature, high-humidity environment, and further progresses rapidly by contact with oils, plasticizers, etc., and color may fade to such an extent that recorded images become illegible. In recent years, disinfection and sterilization with alcohol have become common practice in general life, especially for the prevention of infectious diseases. Thus, there is an increasing demand for improved performance of heat-sensitive recording materials, such as no color development in the blank-paper portion and no color fading in the printed portion even when they come into contact with alcohol.

For example, Patent Literature (PTL) 1 proposes a heat-sensitive recording material containing a diarylurea derivative as a developer. However, the heat-sensitive recording material described in PTL 1 is insufficient in terms of water resistance, water plasticizer resistance, and alcohol resistance, and has room for improvement.

### CITATION LIST

### Patent Literature

PTL 1: WO2019/044462

### SUMMARY OF INVENTION

### Technical Problem

A primary object of the present invention is to provide a heat-sensitive recording material with excellent water resistance and water plasticizer resistance in the recorded portion, and excellent alcohol resistance in the recorded portion and the background portion.

### Solution to Problem

In view of the prior art, the present inventors conducted extensive research and found a solution to the problem. More specifically, the present invention provides the following heat-sensitive recording materials.

### Item 1.

A heat-sensitive recording material comprising at least an undercoat layer and a heat-sensitive recording layer in this order on a support,
the undercoat layer containing an inorganic pigment, hollow particles, and a binder,
the heat-sensitive recording layer containing a leuco dye, developers, and a binder,
the heat-sensitive recording layer containing a first developer and a second developer as the developers, and
the heat-sensitive recording layer containing an N,N′-diarylurea-based compound represented by formula (1) as the second developer:

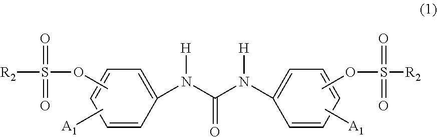

wherein
R₂ represents a C₁₋₁₂ alkyl group, a C₇₋₁₂ aralkyl group, or a C₆₋₁₂ aryl group, the aralkyl group and aryl group may be substituted with a C₁₋₁₂ alkyl group, a C₁₋₁₂ alkoxy group, a C₆₋₁₂ aryl group, or a halogen atom, and a plurality of R₂s may be the same or different; and
A₁ represents a hydrogen atom or a C₁₋₄ alkyl group, and a plurality of A₁s may be the same or different.

### Item 2.

The heat-sensitive recording material according to Item 1, wherein the N,N′-diarylurea-based compound represented by formula (1) is at least one member selected from the group consisting of N,N′-di-[3-(p-toluenesulfonyloxy)phenyl]urea, N,N′-di-[3-(o-toluenesulfonyloxy)phenyl]urea, N,N′-di-[3-(benzenesulfonyloxy)phenyl]urea, N,N′-di-[3-(mesitylenesulfonyloxy)phenyl]urea, N,N′-di-[3-(4-ethylbenzenesulfonyloxy)phenyl]urea, N,N′-di-[3-(2-naphthalenesulfonyloxy)phenyl]urea, N,N′-di-[3-(p-methoxybenzenesulfonyloxy)phenyl]urea, N,N′-di-[3-(benzylsulfonyloxy)phenyl]urea, N,N′-di-[3-(ethanesulfonyloxy)-phenyl]urea, N,N′-di-[3-(p-toluenesulfonyloxy)-4-methyl-phenyl]urea, N,N′-di-[4-(p-toluenesulfonyloxy)phenyl]urea, N,N′-di-[4-(benzenesulfonyloxy)phenyl]urea, N,N′-di-[4-(ethanesulfonyloxy)phenyl]urea, and N,N′-di-[2-(p-toluenesulfonyloxy)]phenylurea.

### Item 3.

The heat-sensitive recording material according to Item 1, wherein the N,N′-diarylurea-based compound represented by formula (1) is N,N′-di-[3-(p-toluenesulfonyl)oxy]phenylurea.

### Item 4.

The heat-sensitive recording material according to any one of Items 1 to 3, wherein a diphenylsulfone derivative represented by formula (2) is contained as the first developer:

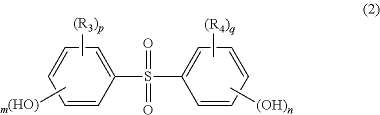

wherein
R₃ and R₄ are the same or different, and each represents C₁₋₄ alkyl group, a C₂₋₄ alkenyl group, a C₁₋₄ alkoxy group, a C₂₋₄ alkenyloxy group, a C₁₋₁₂ aralkyloxy group, or a halogen atom;
m is an integer of 0 to 2;
n is an integer of 1 to 3; and
p and q are the same or different, and each represents an integer of 0 to 2.

### Item 5.

The heat-sensitive recording material according to Item 4, wherein the diphenylsulfone derivative represented by formula (2) is at least one member selected from the group consisting of 4-hydroxy-4′-isopropoxy diphenyl sulfone, 4,4′-dihydroxydiphenyl sulfone, 2,4′-dihydroxydiphenyl sulfone, bis(3-allyl-4-hydroxy)diphenyl sulfone, 4-hydroxyphenyl (4′-n-propoxyphenyl) sulfone, 4-allyloxy-4′-hydroxydiphenyl sulfone, and 4-hydroxy-4′-benzyloxydiphenyl sulfone.

### Item 6.

The heat-sensitive recording material according to any one of Items 1 to 3, wherein the first developer is N-p-tolylsulfonyl-N′-3-(p-tolylsulfonyloxy)phenylurea.

### Item 7.

The heat-sensitive recording material according to any one of Items 1 to 3, wherein the first developer is N-[2-(3-phenylureido)phenyl]benzenesulfonamide.

### Item 8.

The heat-sensitive recording material according to any one of Items 1 to 3, wherein the first developer is 5-(N-3-methylphenyl-sulfonamide)-N′,N″-bis-(3-methylphenyl)-isophthalic acid diamide.

### Item 9.

The heat-sensitive recording material according to any one of Items 1 to 8, wherein the second developer is contained in an amount of 0.1 to 3 parts by mass per part by mass of the first developer.

### Item 10.

The heat-sensitive recording material according to any one of Items 1 to 8, wherein the second developer is contained in an amount of 0.1 to 1 part by mass per part by mass of the first developer.

### Item 11.

The heat-sensitive recording material according to any one of Items 1 to 10, wherein
the hollow particles have a maximum particle diameter (D100) of 10 to 30 μm and an average particle diameter (D50) of 4.0 to 15 μm,
the ratio of the maximum particle diameter (D100) to the average particle diameter (D50), which is D100/D50, is 1.8 to 3.0, and
the volume % of hollow particles with a particle diameter of 2.0 μm or less is 1% or less.

### Item 12.

The heat-sensitive recording material according to any one of Items 1 to 11, wherein the hollow particles have a hollow ratio of 80 to 98%.

### Item 13.

The heat-sensitive recording material according to any one of Items 1 to 12, wherein the binder in the undercoat layer contains a binder resin with a glass transition temperature of −10° C. or lower.

### Item 14.

The heat-sensitive recording material according to any one of Items 1 to 13, wherein the binder in the undercoat layer contains a binder resin with a glass transition temperature of −30° C. or lower.

### Item 15.

The heat-sensitive recording material according to any one of Items 1 to 14, comprising an adhesive layer on at least one surface of the support.

### Advantageous Effects of Invention

The heat-sensitive recording material of the present invention has excellent water resistance and water plasticizer resistance in the recorded portion, and excellent alcohol resistance in the recorded portion and the background portion. The heat-sensitive recording material can also increase the color density.

### DESCRIPTION OF EMBODIMENTS

In the present specification, the expression “comprise” or “contain” includes the concepts of “comprising,” “consisting essentially of,” and “consisting of.”

In the present specification, a numerical range indicated by “ . . . to . . . ” means a range including the numerical values given before and after “to” as the lower limit and the upper limit.

“Latex” as used herein includes one in the form of a gel or dry film formed by drying a dispersion medium.

The present invention relates to a heat-sensitive recording material comprising at least an undercoat layer and a heat-sensitive recording layer in this order on a support,
the undercoat layer containing an inorganic pigment, hollow particles, and a binder,
the heat-sensitive recording layer containing a leuco dye, developers, and a binder,
the heat-sensitive recording layer containing a first developer and a second developer as the developers, and
the heat-sensitive recording layer containing an N,N′-diarylurea-based compound represented by formula (1) as the second developer:

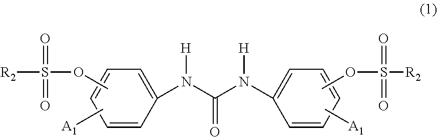

wherein
R₂ represents a C₁₋₁₂ alkyl group, a C₇₋₁₂ aralkyl group, or a C₆₋₁₂ aryl group, the aralkyl group and aryl group may be substituted with a C₁₋₁₂ alkyl group, a C₁₋₁₂ alkoxy group, a C₆₋₁₂ aryl group, or a halogen atom, and a plurality of R₂s may be the same or different; and
A₁ represents a hydrogen atom or a C₁₋₄ alkyl group, and a plurality of A₁s may be the same or different.

### Support

The support in the present invention is not particularly limited in type, shape, dimension, or the like. For example, high-quality paper (acid paper, neutral paper), medium-quality paper, coated paper, art paper, cast-coated paper, glassine paper, resin laminate paper, polyolefin-based synthetic paper, synthetic fiber paper, nonwoven fabrics, synthetic resin films, various transparent supports, or the like, can be appropriately selected and used. The thickness of the support is not particularly limited, and is typically about 20 to 200 μm. The density of the support is not particularly limited, and is preferably about 0.60 to 0.85 g/cm³.

### Undercoat Layer

The heat-sensitive recording material of the present invention comprises an undercoat layer between a support and a heat-sensitive recording layer, and the undercoat layer contains an inorganic pigment, hollow particles, and a binder.

### Hollow Particles

The hollow particles are preferably formed of an organic resin from the viewpoint of enhancing cushioning properties. The undercoat layer that contains the hollow particles and thus has excellent heat-insulating properties can prevent the diffusion of heat applied to the heat-sensitive recording layer and increase the sensitivity of the heat-sensitive recording material.

Hollow particles formed of an organic resin can be divided into foamed and non-foamed types depending on the production method. Of these two types, foamed-type hollow particles typically have a larger average particle diameter and a higher hollow ratio than non-foamed-type hollow particles. Thus, foamed-type hollow particles allow for better sensitivity and image quality than non-foamed-type hollow particles.

Non-foamed-type hollow particles can be produced by polymerizing a seed in a solution, polymerizing another resin so as to cover the seed, and removing the seed inside by swelling and dissolving to form a void inside. An alkaline aqueous solution or the like is used to remove the seed inside by swelling and dissolving. Non-foamed-type hollow particles with a relatively large average particle diameter can also be produced by alkaline swelling treatment of core-shell particles in which core particles having alkaline swelling properties are coated with a shell layer that does not have alkaline swelling properties.

Foamed-type hollow particles can be produced by preparing particles in which a volatile liquid is sealed in a resin, and vaporizing and expanding the liquid in the particles while softening the resin by heating.

In the process of producing foamed-type hollow particles, the liquid in the particles is expanded by heating, thereby increasing the hollow ratio and providing excellent heat-insulating properties; thus, use of foamed-type hollow particles can enhance the sensitivity of the heat-sensitive recording material and improve the recording density. The improvement in sensitivity is particularly important in color development in a medium energy range, in which the thermal energy applied to the heat-sensitive recording layer is small. In addition, when the heat-sensitive recording layer is formed via an undercoat layer with excellent heat-insulating properties, the diffusion of heat applied to the heat-sensitive recording layer is prevented, resulting in excellent image uniformity and improved image quality. Thus, in this embodiment, it is preferable to use foamed-type hollow particles, which are excellent in improvement in the heat-insulating properties of the undercoat layer.

Examples of the resin that can be used for foamed-type hollow particles include thermoplastic resins, such as styrene-acrylic resins, polystyrene resins, acrylic resins, polyethylene resins, polypropylene resins, polyacetal resins, chlorinated polyether resins, polyvinyl chloride resins, polyvinylidene chloride resins, acrylic-based resins (e.g., an acrylic-based resin containing acrylonitrile as a component), styrene-based resins, vinylidene chloride-based resins, and copolymer resins mainly formed of polyvinylidene chloride and acrylonitrile. As gases contained in foamed-type hollow particles, propane, butane, isobutane, air, etc. can be typically used. Of the various resins, acrylonitrile resins and copolymer resins mainly formed of polyvinylidene chloride and acrylonitrile are preferred as resins that can be used for the hollow particles, from the viewpoint of the strength to maintain the shape of foamed particles.

The maximum particle diameter of the hollow particles in the present invention is preferably 10 to 30 μm, and more preferably 15 to 25 μm. The maximum particle diameter is also referred to as “D100.” When the maximum particle diameter of the hollow particles is 10 μm or more, the cushioning properties of the undercoat layer are improved; thus, the adhesion of the heat-sensitive recording material to a thermal head during printing is improved, and a heat-sensitive recording material with high image quality is obtained. This high image quality can result in improved recording density in a medium energy range, in which color is developed with energy lower than that for providing the maximum recording density (Dmax). When the maximum particle diameter of the hollow particles is 30 μm or less, the smoothness of the undercoat layer is improved; thus, the heat-sensitive recording layer provided via the undercoat layer can be made uniform, and a heat-sensitive recording material in which the formation of white spots in an image is less likely to occur can be obtained.

The average particle diameter of the hollow particles in the present invention is preferably 4.0 to 15 μm, and more preferably 7.5 to 15 μm. The average particle diameter as used herein is the diameter at which the volume of larger particles is equal to the volume of smaller particles when particles are divided into two kinds based on the particle diameter, i.e., the median diameter, which is the particle diameter corresponding to 50 volume % frequency. The average particle diameter is also referred to as “D50.” When the average particle diameter of the hollow particles is 4.0 μm or more, the cushioning properties of the undercoat layer are improved; thus, the adhesion of the heat-sensitive recording material to a thermal head during printing is improved, and a heat-sensitive recording material with high image quality is obtained. This high image quality can result in improved recording density in a medium energy range, in which color is developed with energy lower than that for providing the maximum recording density (Dmax). When the average particle diameter of the hollow particles is 15 μm or less, the smoothness of the undercoat layer is improved; thus, the heat-sensitive recording layer provided via the undercoat layer can be made uniform, and a heat-sensitive recording material in which the formation of white spots in an image is less likely to occur can be obtained.

The maximum particle diameter (D100) and average particle diameter (D50) of the hollow particles can be measured using a laser diffraction particle diameter distribution analyzer. The average particle diameter (D50) may be shown according to the average value of particle diameters of 10 particles, the particle diameters being measured from the image of each particle with an electron microscope (SEM image).

The ratio of the maximum particle diameter (D100) of the hollow particles to the average particle diameter (D50) of the hollow particles, i.e., D100/D50, is an index showing the degree of particle diameter distribution. The D100/D50 ratio is preferably 1.8 to 3.0, and more preferably 2.0 to 2.8. When the D100/D50 ratio of the hollow particles is 1.8 or more, the hollow particles can be sufficiently foamed, the maximum particle diameter can be sufficiently large, the hollow ratio can be high, and the heat-insulating properties of the undercoat layer can be improved. When the D100/D50 ratio of the hollow particles is 3.0 or less, the sizes of the hollow particles are uniform, which improves the smoothness of the undercoat layer and suppresses white spots in an image.

In a particle diameter distribution determined with a laser diffraction particle diameter distribution analyzer, the volume % of hollow particles having a particle diameter of 2.0 μm or less is preferably 11 or less. It is also preferred that the volume % of hollow particles having a particle diameter of 2.0 μm or less is 0.5% or less, and it is more preferred that hollow particles having a particle diameter of 2.0 μm or less are not contained. Hollow particles having a particle diameter of 2 μm or less are considered to have a very small contribution to heat-insulating properties because they are too small to have a sufficient hollow area. When the volume % of hollow particles having a particle diameter of 2 μm or less in the undercoat layer is 1% or less, the recording density, image quality, etc. can be improved.

The hollow ratio of the hollow particles is preferably 80 to 98%, and more preferably 90 to 98%. When the hollow ratio of the hollow particles is 80% or more, excellent heat-insulating properties can be imparted to the undercoat layer containing the hollow particles. When the hollow ratio of the hollow particles is 98% or less, the strength of the film surrounding the hollow portion is improved, and thus hollow particles that do not collapse even when the undercoat layer is formed can be obtained.

The hollow ratio of the hollow particles is determined by measuring the true specific gravity according to the IPA method, and using the true specific gravity value as follows.

### (1) Sample Pretreatment

A sample is dried at 60° C. around the clock.

### (2) Reagent

Isopropyl alcohol (IPA: extra-pure reagent)
   (3) Measurement method
A volumetric flask is weighed (W1).
About 0.5 g of the dried sample is weighed in the volumetric flask (W2).
About 50 mg of IPA is added thereto, and the volumetric flask is fully shaken to completely remove air outside the capsule.
IPA is added to the marked line, and the volumetric flask is weighed (W3).
As a blank, IPA alone is added to the marked line of a volumetric flask, and the volumetric flask is weighed (W4).

### (4) Calculation of True Specific Gravity

True specific gravity={(W2−W1)×((W4−W1)/100)}/{(W4−W1)−(W3−W2)}

### (5) Calculation of Hollow Ratio

Hollow ratio (%)={1−1/(1.1/true specific gravity)}×100

The hollow ratio is a value that can also be determined according to the following formula: (d³/D³)×100. In the formula, d represents the inner diameter of the hollow particles, and D represents the outer diameter of the hollow particles.

Since the hollow particles in the present invention have a relatively large particle diameter, the content of the hollow particles in the undercoat layer can be reduced. The content of the hollow particles is preferably 3 to 40 mass %, and more preferably 5 to 35 mass %, based on the total solids content of the undercoat layer. A hollow particle content of 3 mass % or more can improve the heat-insulating properties of the undercoat layer, whereas a hollow particle content of 40 masse or less makes it less likely to cause problems in terms of coating properties and the like, and makes it possible to easily form a uniform undercoat layer and improve the recording density. Further, the coating film strength of the undercoat layer can be increased.

### Binder

Examples of binders include water-soluble polymeric materials, such as polyvinyl alcohol and derivatives thereof, starch and derivatives thereof, cellulose derivatives, such as hydroxymethylcellulose, hydroxyethylcellulose, hydroxypropylcellulose, carboxymethylcellulose, methylcellulose, and ethylcellulose, sodium polyacrylate, polyvinylpyrrolidone, acrylamide-acrylic acid ester copolymers, acrylamide-acrylic acid ester-methacrylic acid ester copolymers, styrene-maleic anhydride copolymers, isobutylene-maleic anhydride copolymers, casein, gelatin, and derivatives thereof; emulsions, such as polyvinyl acetate, polyurethane, polyacrylic acid, polyacrylic acid ester, vinyl chloride-vinyl acetate copolymers, polybutyl methacrylate, and ethylene-vinyl acetate copolymers; latexes of water-insoluble polymers, such as styrene-butadiene copolymers and styrene-butadiene-acrylic copolymers; and the like. Of these, it is preferable to use a binder containing a latex. The content of the binder can be selected from a wide range, and is typically preferably about 20 to 70 mass, and more preferably about 25 to 60 mass, based on the total solids content of the undercoat layer.

The binder preferably contains a binder resin with a glass transition temperature (Tg) of −10° C. or lower. When the glass transition temperature is −10° C. or lower, image quality can be improved even in a low energy range. The glass transition temperature is more preferably −30° C. or lower because image quality can be further improved in a low energy range. A glass transition temperature of −50° C. or lower is not preferable because stickiness occurs. Thus, the glass transition temperature is preferably −40° C. or higher.

### Inorganic Pigment

The undercoat layer of the present invention contains an inorganic pigment. The oil absorption of the inorganic pigment is preferably 130 ml/100 g or less, more preferably 125 ml/100 g or less, and even more preferably 110 ml/100 g or less, from the viewpoint of increasing recording density and improving water plasticizer resistance and alcohol resistance. The oil absorption of the inorganic pigment is also preferably 50 ml/100 g or more, and more preferably 80 ml/100 g or more, from the viewpoint of effectively reducing printing problems such as head residue and sticking. The oil absorption is a value determined according to the method of JIS K 5101.

Various inorganic pigments can be used as the inorganic pigment, and preferred examples include calcined kaolin, clay, and the like. The content of the inorganic pigment is preferably 60 mass % or less, and more preferably 50 mass % or less, based on the total solids content of the undercoat layer, from the viewpoint of improving color sensitivity. The content of the inorganic pigment is also preferably 20 masse or more, and more preferably 25 mass % or more, based on the total solids content of the undercoat layer, from the viewpoint of effectively reducing printing problems such as head residue and sticking.

The undercoat layer is formed on a support, for example, by mixing hollow particles, a binder, and an inorganic pigment, and if necessary, an auxiliary agent and the like using water as a medium to prepare a coating composition for an undercoat layer, applying the coating composition to the support, and then drying. The coated amount of the coating composition for an undercoat layer is not particularly limited, and is preferably about 2 to 20 g/m², and more preferably about 2 to 12 g/m² in terms of dry mass.

### Heat-Sensitive Recording Layer

### Leuco Dye

The heat-sensitive recording layer of the heat-sensitive recording material of the present invention may contain any of various known colorless or pale-colored leuco dyes. Specific examples of such leuco dyes are described below.

Specific examples of leuco dyes include dyes capable of developing blue color, such as 3,3-bis(p-dimethylaminophenyl)-6-dimethylaminophthalide, 3-(4-diethylamino-2-methylphenyl)-3-(4-dimethylaminophenyl)-6-dimethylaminophthalide, and fluoran; dyes capable of developing green color, such as 3-(N-ethyl-N-p-tolyl)amino-7-N-methylanilinofluoran, 3-diethylamino-7-anilinofluoran, 3-diethylamino-7-dibenzylaminofluoran, and rhodamine B-anilinolactam; dyes capable of developing red color, such as 3,6-bis(diethylamino)fluoran-γ-anilinolactam, 3-cyclohexylamino-6-chlorofluoran, 3-diethylamino-6-methyl-7-chlorofluoran, and 3-diethylamino-7-chlorofluoran; dyes capable of developing black color, such as 3-(N-ethyl-N-isoamyl)amino-6-methyl-7-anilinofluoran, 3-(N-methyl-N-cyclohexyl)amino-6-methyl-7-anilinofluoran, 3-diethylamino-6-methyl-7-anilinofluoran, 3-di(n-butyl)amino-6-methyl-7-anilinofluoran, 3-di(n-pentyl)amino-6-methyl-7-anilinofluoran, 3-(N-ethyl-N-isoamylamino)-6-methyl-7-anilinofluoran, 3-diethylamino-7-(m-trifluoromethylanilino)fluoran, 3-(N-isoamyl-N-ethylamino)-7-(o-chloroanilino)fluoran, 3-(N-ethyl-N-2-tetrahydrofurfurylamino)-6-methyl-7-anilinofluoran, 3-(N-n-hexyl-N-ethylamino)-6-methyl-7-anilinofluoran, 3-[N-(3-ethoxypropyl)-N-ethylamino]-6-methyl-7-anilinofluoran, 3-[N-(3-ethoxypropyl)-N-methylamino]-6-methyl-7-anilinofluoran, 3-diethylamino-7-(2-chloroanilino)fluoran, 3-di(n-butylamino)-7-(2-chloroanilino)fluoran, 4,4′-bis-dimethylaminobenzhydrinbenzyl ether, N-2,4,5-trichlorophenylleucoauramine, 3-diethylamino-7-butylaminofluoran, 3-ethyl-tolylamino-6-methyl-7-anilinofluoran, 3-cyclohexyl-methylamino-6-methyl-7-anilinofluoran, 3-diethylamino-6-chloro-7-(β-ethoxyethyl)aminofluoren, 3-diethylamino-6-chloro-7-(γ-chloropropyl)aminofluoren, 3-diethylamino-6-methyl-7-anilinofluoran, 3-(N-isoamyl-N-ethylamino)-6-methyl-7-anilinofluoran, 3-dibutylamino-7-chloroanilinofluoran, 3-diethylamino-7-(o-chlorophenylamino)fluoran, 3-(N-ethyl-p-toluidino)-6-methyl-7-anilinofluoran, 3-(N-ethyl-p-toluidino)-6-methyl-7-(p-toluidino)fluoran, 3-(N-ethyl-N-tetrahydrofurfurylamino)-6-methyl-7-anilinofluoran, 3-diethylamino-6-chloro-7-anilinofluoran, 3-dimethylamino-6-methyl-7-anilinofluoran, 3-pyrrolidino-6-methyl-7-anilinofluoran, 3-piperidino-6-methyl-7-anilinofluoran, 2,2-bis{4-[6′-(N-cyclohexyl-N-methylamino)-3′-methylspiro[phthalide-3,9′-xanthen-2′-ylamino]phenyl}propane, and 3-diethylamino-7-(3′-trifluoromethylphenyl)aminofluoren; dyes having absorption wavelengths in the near-infrared region, such as 3,3-bis[1-(4-methoxyphenyl)-1-(4-dimethylaminophenyl)ethylen-2-yl]-4,5,6,7-tetrachlorophthalide, 3,3-bis[1-(4-methoxyphenyl)-1-(4-pyrrolidinophenyl)ethylen-2-yl]-4,5,6,7-tetrachlorophthalide, 3-p-(p-dimethylaminoanilino)anilino-6-methyl-7-chlorofluoran, 3-p-(p-chloroanilino)anilino-6-methyl-7-chlorofluoran, and 3,6-bis(dimethylamino)fluorene-9-spiro-3′-(6′-dimethylamino)phthalide; and the like. Usable leuco dyes are, of course, not limited to these compounds, and two or more of such compounds can be used in combination as necessary.

The content of the leuco dye is not particularly limited, and is preferably about 3 to 30 mass %, more preferably about 5 to 25 mass %, and even more preferably about 7 to 20 mass %, based on the total solids content of the heat-sensitive recording layer. A leuco dye content of 3 mass % or more can enhance color development ability and thus improve recording density, whereas a leuco dye content of 30 mass % or less can enhance heat resistance.

### Developers

In the present invention, a first developer and a second developer are contained as developers, and an N,N′-diarylurea-based compound represented by formula (1) described above is contained as the second developer. The first developer is the main developer, and the second developer also has the effect of improving preservation. Thus, excellent water resistance, water plasticizer resistance, alcohol resistance, etc. can be exhibited.

Specific examples of the first developer include phenolic compounds, such as 4-tert-butylphenol, 4-acetylphenol, 4-tert-octylphenol, 4,4′-sec-butylidenediphenol, 4-phenylphenol, 4,4′-dihydroxydiphenylmethane, 4,4′-isopropylidenediphenol, 4,4′-cyclohexylidenediphenyl, 4,4′-cyclohexylidenediphenol, 1,1-bis(4-hydroxyphenyl)-ethane, 1,1-bis(4-hydroxyphenyl)-1-phenylethane, 4,4′-bis(p-tolylsulfonylaminocarbonylamino)diphenylmethane, 1,1-bis(4-hydroxyphenyl)cyclohexane, 2,2′-bis[4-(4-hydroxyphenyl)phenoxy]diethyl ether, 4,4′-dihydroxydiphenylsulfide, 4,4′-thiobis(3-methyl-6-tert-butylphenol), 4,4′-dihydroxydiphenyl sulfone, 2,4′-dihydroxydiphenyl sulfone, 2,2-bis(4-hydroxyphenyl)-4-methylpentane, 4-hydroxy-4′-isopropoxy diphenyl sulfone, 4-hydroxyphenyl(4′-n-propoxyphenyl)sulfone, 4-hydroxy-4′-benzyloxydiphenyl sulfone, 3,3′-diallyl-4,4′-dihydroxydiphenylsulfone, butyl bis(p-hydroxyphenyl)acetate, methyl bis(p-hydroxyphenyl)acetate, hydroquinone monobenzyl ether, bis(3-allyl-4-hydroxyphenyl)sulfone, 4-hydroxy-4′-methyldiphenylsulfone, 4-allyloxy-4′-hydroxydiphenyl sulfone, 3,4-dihydroxyphenyl-4′-methylphenylsulfone, 4-hydroxybenzophenone, dimethyl 4-hydroxyphthalate, methyl 4-hydroxybenzoate, propyl 4-hydroxybenzoate, sec-butyl 4-hydroxybenzoate, phenyl 4-hydroxybenzoate, benzyl 4-hydroxybenzoate, 4-hydroxybenzoic acid benzyl ester, tolyl 4-hydroxybenzoate, chlorophenyl 4-hydroxybenzoate, and 4,4′-dihydroxydiphenyl ether; aromatic carboxylic acids, such as benzoic acid, p-chlorobenzoic acid, p-tert-butylbenzoic acid, trichlorobenzoic acid, terephthalic acid, salicylic acid, 3-tert-butylsalicylic acid, 3-isopropylsalicylic acid, 3-benzoylsalicylic acid, 3-(α-methylbenzyl)salicylic acid, 3,5-di-tert-butylsalicylic acid, 4-[2-(p-methoxyphenoxy)ethyloxy]salicylic acid, 4-[3-(p-tolylsulfonyl)propyloxy]salicylic acid, 5-[p-(2-p-methoxyphenoxyethoxy)cumyl]salicylic acid, and zinc 4-[3-(p-tolylsulfonyl)propyloxy]salicylate; salts of these phenolic compounds or aromatic carboxylic acids with, for example, polyvalent metals, such as zinc, magnesium, aluminum, calcium, titanium, manganese, tin, and nickel; antipyrine complex of zinc thiocyanate; organic acidic substances, such as composite zinc salts of terephthalic aldehyde acid and other aromatic carboxylic acids; thiourea compounds, such as N-p-tolylsulfonyl-N′-3-(p-tolylsulfonyloxy)phenylurea, N-p-tolylsulfonyl-N′-p-butoxycarbonylphenylurea, N-p-tolylsulfonyl-N′-phenylurea, 4,4′-bis(p-toluenesulfonylaminocarbonylamino)diphenylmethane, and N,N′-di-m-chlorophenylthiourea; organic compounds having a —SO₂NH-bond in the molecule, such as N-(p-toluenesulfonyl)carbamic acid p-cumylphenyl ester, N-(p-toluenesulfonyl)carbamic acid p-benzyloxyphenyl ester, N-[2-(3-phenylureido)phenyl]benzenesulfonamide, N-(o-toluoyl)-p-toluenesulfonamide, and 5-(N-3-methylphenyl-sulfonamide)-N′,N″-bis-(3-methylphenyl)-isophthalic acid diamide; inorganic acidic substances, such as activated clay, attapulgite, colloidal silica, and aluminum silicate; and the like. The first developer is of course not limited to these, and the first developer for use may be a combination of two or more compounds as necessary.

It is preferred that the heat-sensitive recording layer of the present invention contains a diphenylsulfone derivative represented by formula (2) above as the first developer. This can further improve the color density.

In formula (2), the C₁₋₄ alkyl group for R₃ or R₄ may be linear or branched, and examples include a methyl group, an ethyl group, an n-propyl group, an isopropyl group, an n-butyl group, an isobutyl group, a sec-butyl group, a t-butyl group, and the like. The alkyl group as used herein also includes the alkyl moiety of a C₁₋₄ alkoxy group. The C₂₋₄ alkenyl group may be linear or branched, and examples include a vinyl group, an n-propenyl group, an n-butenyl group, and the like. The alkenyl group as used herein also includes the alkenyl moiety of a C₂₋₄ alkenyloxy group. The aralkyl group refers to an aryl alkyl group, and examples of a C₇₋₁₂ aralkyl group include a benzyl group, a 1-phenylethyl group, a 2-phenylethyl group, a 3-phenylpropyl group, and the like. Examples of the halogen atom include fluorine, chlorine, bromine, and iodine. If there are a plurality of R₃s and/or R₄s, they may be the same or different.

The position of substitution of R₃, R₄, or OH is not particularly limited, and the 3-position, 4-position, or 5-position is preferable. m is preferably 0 or 1, n is preferably 1, and it is preferred that p and q are the same or different and that each is 0 or 1.

The diphenylsulfone derivative represented by formula (2) is not particularly limited and is preferably at least one member selected from the group consisting of 4-hydroxy-4′-isopropoxy diphenyl sulfone, 4,4′-dihydroxydiphenyl sulfone, 2,4′-dihydroxydiphenyl sulfone, bis(3-allyl-4-hydroxy)diphenyl sulfone, 4-hydroxyphenyl(4′-n-propoxyphenyl)sulfone, 4-allyloxy-4′-hydroxydiphenyl sulfone, and 4-hydroxy-4′-benzyloxydiphenyl sulfone.

In the present invention, the first developer is also preferably N-p-tolylsulfonyl-N′-3-(p-tolylsulfonyloxy)phenylurea. This provides an excellent balance between color density and preservation, and allows the effects of the present invention to be fully demonstrated.

In the present invention, the first developer is also preferably N-[2-(3-phenylureido)phenyl]benzenesulfonamide. This provides an excellent balance between color density and preservation, and allows the effects of the present invention to be fully demonstrated.

In the present invention, the first developer is also preferably 5-(N-3-methylphenyl-sulfonamide)-N′,N″-bis-(3-methylphenyl)-isophthalic acid diamide. This provides an excellent balance between color density and preservation, and allows the effects of the present invention to be fully demonstrated.

In formula (1) of the N,N′-diarylurea-based compound contained as the second developer, the C₁₋₁₂ alkyl group for R₂ may be linear, branched, or alicyclic, and preferably a C₁₋₆ alkyl group, and more preferably a C₁₋₃ alkyl group. Examples of C₁₋₁₂ alkyl groups include a methyl group, an ethyl group, an n-propyl group, an i-propyl group, an n-butyl group, an i-butyl group, a t-butyl group, a cyclopentyl group, a hexyl group, a cyclohexyl group, a 2-ethylhexyl group, a lauryl group, and the like. The alkyl group as used here also includes the alkyl moiety of a C₁₋₁₂ alkoxy group.

The aralkyl group refers to an aryl alkyl group, and examples of C₇₋₁₂ aralkyl groups include a benzyl group, a 1-phenylethyl group, a 2-phenylethyl group, and a 3-phenylpropyl group.

The aryl group means a monocyclic or polycyclic group formed of one or more 5- or 6-membered aromatic hydrocarbon rings. Examples of C₆₋₁₂ aryl groups include a phenyl group, a 1-naphthyl group, a 2-naphthyl group, and the like. The aryl group as used herein also includes the aryl moiety of aralkyl groups.

Examples of halogen atoms include fluorine, chlorine, bromine, and iodine.

In formula (1), the position of substitution of each R₂—SO₃— may be the same or different. The substitution position is preferably the 3-position, the 4-position, or the 5-position, and more preferably the 3-position. When the C₇₋₁₂ aralkyl group and the C₆₋₁₂ aryl group represented by R₂ are substituted, the number of substituents is not particularly limited, and is for example, 1 to 4.

The C₁₋₄ alkyl group represented by A₁ may be linear or branched. Examples include a methyl group, an ethyl group, an n-propyl group, an isopropyl group, an n-butyl group, an isobutyl group, a sec-butyl group, t-butyl group, and the like.

The substitution position of each A₁ may be the same or different. The substitution position is preferably the 3-position, the 4-position, or the 5-position.

The N,N′-diarylurea-based compound represented by formula (1) is not particularly limited, and is preferably at least one member selected from the group consisting of N,N′-di-[3-(p-toluenesulfonyloxy)phenyl]urea, N,N′-di-[3-(o-toluenesulfonyloxy)phenyl]urea, N,N′-di-[3-(benzenesulfonyloxy)phenyl]urea, N,N′-di-[3-(mesitylenesulfonyloxy)phenyl]urea, N,N′-di-[3-(4-ethylbenzenesulfonyloxy)phenyl]urea, N,N′-di-[3-(2-naphthalenesulfonyloxy)phenyl]urea, N,N′-di-[3-(p-methoxybenzenesulfonyloxy)phenyl]urea, N,N′-di-[3-(benzylsulfonyloxy)phenyl]urea, N,N′-di-[3-(ethanesulfonyloxy)phenyl]urea, N,N′-di-[3-(p-toluenesulfonyloxy)-4-methyl-phenyl]urea, N,N′-di-[4-(p-toluenesulfonyloxy)phenyl]urea, N,N′-di-[4-(benzenesulfonyloxy)phenyl]urea, N,N′-di-[4-(ethanesulfonyloxy)phenyl]urea, and N,N′-di-[2-(p-toluenesulfonyloxy)]phenylurea. Of these, N,N′-di-[3-(p-toluenesulfonyloxy)phenyl]urea is preferred.

The content of the first developer is preferably about 0.2 to 3 parts by mass per part by mass of the leuco dye. The content of the second developer is preferably about 0.1 to 3 parts by mass, and more preferably about 0.1 to 1 part by mass, per part by mass of the first developer. A second developer content of 0.1 parts by mass or more can improve preservation. A second developer content of 3 parts by mass or less can improve color density.

The content of the N,N′-diarylurea-based compound is not particularly limited, and can be adjusted according to the leuco dye for use. Typically, the content of the N,N′-diarylurea-based compound is preferably 0.1 parts by mass or more, more preferably 0.2 parts by mass or more, and even more preferably 0.4 parts by mass or more, per part by mass of the leuco dye. The content of the N,N′-diarylurea-based compound is also preferably 6 parts by mass or less, more preferably 5 parts by mass or less, and even more preferably 4 parts by mass or less, per part by mass of the leuco dye. A content of 0.1 parts by mass or more can enhance water resistance, water plasticizer resistance, and alcohol resistance. A content of 6 parts by mass or less can enhance recording performance.

### Binder

Examples of binders include water-soluble polymeric materials, such as polyvinyl alcohol and derivatives thereof, starch and derivatives thereof, cellulose derivatives, such as hydroxymethylcellulose, hydroxyethylcellulose, hydroxypropylcellulose, methylcellulose, and ethylcellulose, sodium polyacrylate, polyvinylpyrrolidone, acrylamide-acrylic acid ester copolymers, acrylamide-acrylic acid ester-methacrylic acid ester copolymers, styrene-maleic anhydride copolymers, isobutylene-maleic anhydride copolymers, casein, gelatin, and derivatives thereof; emulsions, such as polyvinyl acetate, polyurethane, polyacrylic acid, polyacrylic acid ester, vinyl chloride-vinyl acetate copolymers, polybutyl methacrylate, and ethylene-vinyl acetate copolymers; latexes of water-insoluble polymers, such as styrene-butadiene copolymers and styrene-butadiene-acrylic copolymers; and the like. Of these, polyvinyl alcohol, latexes, and the like are preferred. The content of the binder can be selected from a wide range, and is typically preferably about 5 to 30 mass %, and more preferably about 10 to 20 mass %, based on the total solids content of the heat-sensitive recording layer.

In the present invention, the heat-sensitive recording layer may further contain a stabilizer mainly in order to further enhance the preservation of the developed color image. As such a stabilizer, it is possible to use, for example, at least one member selected from the group consisting of phenol compounds, such as 1,1,3-tris(2-methyl-4-hydroxy-5-cyclohexylphenyl)butane, 1,1,3-tris(2-methyl-4-hydroxy-5-tert-butylphenyl)butane, 1,1-bis(2-methyl-4-hydroxy-5-tert-butylphenyl)butane, 4,4′-[1,4-phenylenebis(1-methylethylidene)]bisphenol, and 4,4′-[1,3-phenylenebis(1-methylethylidene)]bisphenol; epoxy compounds, such as 4-benzyloxyphenyl-4′-(2-methyl-2,3-epoxypropyloxy)phenylsulfone, 4-(2-methyl-1,2-epoxyethyl)diphenylsulfone, and 4-(2-ethyl-1,2-epoxyethyl)diphenylsulfone; and isocyanuric acid compounds, such as 1,3,5-tris(2,6-dimethylbenzyl-3-hydroxy-4-tert-butyl)isocyanuric acid. Usable stabilizers are, of course, not limited to these compounds, and two or more of such compounds can be used in combination as necessary.

When the stabilizer is used, its amount may be an effective amount for improving image preservation. The stabilizer is typically preferably used in an amount of about 1 to 25 mass %, and more preferably about 5 to 20 mass %, based on the total solids content of the heat-sensitive recording layer.

In the present invention, the heat-sensitive recording layer may further contain a sensitizer. Use of the sensitizer enhances the recording sensitivity. Examples of usable sensitizers include stearic acid amide, methoxycarbonyl-N-stearic acid benzamide, N-benzoyl stearic acid amide, N-eicosanoic acid amide, ethylenebisstearic acid amide, behenic acid amide, methylenebisstearic acid amide, N-methylol stearic acid amide, dibenzyl terephthalate, dimethyl terephthalate, dioctyl terephthalate, diphenylsulfone, benzyl p-benzyloxybenzoate, phenyl 1-hydroxy-2-naphthoate, 2-naphthyl benzyl ether, m-terphenyl, p-benzylbiphenyl, oxalic acid-di-p-chlorobenzyl ester, oxalic acid-di-p-methylbenzyl ester, oxalic acid-dibenzyl ester, p-tolyl biphenyl ether, di(p-methoxyphenoxyethyl)ether, 1,2-di(3-methylphenoxy)ethane, 1,2-di(4-methylphenoxy)ethane, 1,2-di(4-methoxyphenoxy) ethane, 1,2-di(4-chlorophenoxy) ethane, 1,2-diphenoxyethane, 1-(4-methoxyphenoxy)-2-(3-methylphenoxy)ethane, p-methylthiophenylbenzylether, 1,4-di(phenylthio)butane, p-acetotoluidide, p-acetophenetidide, N-acetoacetyl-p-toluidine, 1,2-diphenoxymethylbenzene, di(β-biphenylethoxy)benzene, p-di(vinyloxyethoxy)benzene, 1-isopropylphenyl-2-phenylethane, di-o-chlorobenzyl adipate, 1,2-bis(3,4-dimethylphenyl)ethane, 1,3-bis(2-naphthoxy)propane, diphenyl, benzophenone, and the like. Of these, 1,2-di(3-methylphenoxy)ethane is preferred from the viewpoint of an excellent balance between color density and preservation. These sensitizers can be used in combination as long as the combined use does not impair the effects of the present invention. The sensitizer content may be an effective amount for sensitization, and is typically preferably 2 to 25 mass %, more preferably 5 to 20 mass %, and even more preferably 5 to 15 mass %, based on the total solids content of the heat-sensitive recording layer.

The heat-sensitive recording layer may contain a fine particle pigment having high whiteness and an average particle diameter of 10 μm or less, from the viewpoint of enhancing the whiteness of the heat-sensitive recording layer and improving the uniformity of the obtained image. Examples of usable fine particle pigments include inorganic pigments, such as calcium carbonate, magnesium carbonate, kaolin, clay, talc, calcined clay, silica, diatomaceous earth, synthetic aluminum silicate, zinc oxide, titanium oxide, aluminum hydroxide, barium sulfate, surface-treated calcium carbonate, and surface-treated silica; and organic pigments, such as urea-formalin resin, styrene-methacrylic acid copolymer resin, and polystyrene resin. The fine particle pigment content is preferably an amount that does not reduce the recording density, that is, 50 mass % or less, based on the total solids content of the heat-sensitive recording layer.

As other components that constitute the heat-sensitive recording layer, a binder can be used. Further, if necessary, auxiliary agents, such as crosslinking agents, waxes, metal soaps, water resistance improving agents, dispersants, colored dyes, and fluorescent dyes, can be used.

When the heat-sensitive recording layer contains a crosslinking agent, the water resistance of the heat-sensitive recording layer can be improved. Examples of crosslinking agents include aldehyde compounds, such as glyoxal; polyamine compounds, such as polyethyleneimine; epoxy compounds, polyamide resins, melamine resins, glyoxylic acid salts, dimethylolurea compounds, aziridine compounds, block isocyanate compounds; inorganic compounds, such as ammonium persulfate, ferric chloride, magnesium chloride, soda tetraborate, and potassium tetraborate; boric acid, boric acid triesters, boron polymers, hydrazide compounds, glyoxylic acid salts, and the like. These may be used singly, or in a combination of two or more. The amount of the crosslinking agent used is preferably about 1 to 5 mass, based on the total solids content of the heat-sensitive recording layer.

The heat-sensitive recording layer is formed on the undercoat layer, for example, by dispersing a leuco dye and developers, and if necessary, with or separately from a sensitizer and a stabilizer, using water as a dispersion medium and using at least one of various stirrers or wet pulverizers, such as a ball mill, a co-ball mill, an attritor, or a vertical or horizontal sand mill together with a water-soluble synthetic polymer compound, such as polyacrylamide, polyvinyl pyrrolidone, polyvinyl alcohol, methylcellulose, or a styrene-maleic anhydride copolymer salt, and other additives such as a surfactant to form dispersions; then mixing the dispersions obtained by reducing the average particle diameter so that the average particle diameter is 2 μm or less with a binder, and optionally further mixing therewith an inorganic pigment, an auxiliary agent, and the like to prepare a coating composition for a heat-sensitive recording layer; applying the coating composition for a heat-sensitive recording layer to the undercoat layer; and then drying. The coated amount of the heat-sensitive recording layer is not particularly limited and is preferably about 1 to 12 g/m², more preferably 2 to 10 g/m², even more preferably 2.5 to 8 g/m², and particularly preferably 3 to 5.5 g/m², in terms of the coated amount after drying. Note that the heat-sensitive recording layer may be formed as two or more separate layers if necessary, and the composition and coated amount of each layer may be the same or different.

### Protective Layer

The heat-sensitive recording material can comprise a protective layer formed on the heat-sensitive recording layer as necessary. The protective layer preferably contains a pigment and a binder. The protective layer preferably further contains a lubricant, such as polyolefin wax or zinc stearate, for the purpose of preventing the layer from sticking to the thermal head. The protective layer can also contain a UV absorber. When a glossy protective layer is formed, the obtained product can have increased added value.

The pigment contained in the protective layer is not particularly limited. Examples include inorganic pigments, such as amorphous silica, kaolin, clay, light calcium carbonate, heavy calcium carbonate, calcined kaolin, titanium oxide, magnesium carbonate, aluminum hydroxide, colloidal silica, and synthetic layered mica; plastic pigments, such as urea-formalin resin fillers; and the like.

The binder contained in the protective layer is not particularly limited, and an aqueous binder selected from water-soluble binders and water-dispersible binders can be used. The binder can be appropriately selected from those that can be used for the heat-sensitive recording layer. Of these, various modified polyvinyl alcohols, such as acetoacetyl-modified polyvinyl alcohol, carboxy-modified polyvinyl alcohol, and diacetone-modified polyvinyl alcohol, can be more preferably used.

The protective layer is formed on the heat-sensitive recording layer, for example, by mixing a pigment and a binder optionally with an auxiliary agent and the like using water as a dispersion medium to prepare a coating composition for a protective layer, applying the coating composition to the heat-sensitive recording layer, and then drying. The coated amount of the coating composition for a protective layer is not particularly limited and is preferably about 0.3 to 15 g/m², more preferably about 0.3 to 10 g/m², even more preferably about 0.5 to 8 g/m², particularly preferably about 1 to 8 g/m², and further particularly preferably about 1 to 5 g/m², in terms of dry mass. The protective layer may be formed as two or more separate layers if necessary, and the composition and coated amount of each layer may be the same or different.

### Other Layers

In the present invention, the heat-sensitive recording material preferably comprises an adhesive layer on at least one surface of the support. This can increase the added value of the heat-sensitive recording material. For example, adhesive paper, remoistening adhesive paper, or delayed tack paper can be formed as the adhesive layer by subjecting one surface of the support to coating with, for example, an adhesive, such as an adhesive, a remoistening adhesive, or a delayed tack adhesive. Recording paper capable of two-sided recording can also be formed by imparting to the surface of the support opposite to the heat-sensitive recording layer a function as heat transfer paper, ink jet recording paper, carbon-free paper, electrostatic recording paper, or xerography paper. Of course, the heat-sensitive recording material can be formed into a two-side heat-sensitive recording material. A back layer can also be provided to inhibit oil and plasticizer permeation from the back side of the heat-sensitive recording material, or for curl control and antistatic purposes. The heat-sensitive recording material can also be formed into linerless labels that do not require release paper by forming a silicone-containing release layer on the protective layer and applying an adhesive to the one side.

### Heat-Sensitive Recording Material

The heat-sensitive recording material can be produced by forming each layer described above on the support. Any known coating method, such as an air knife method, a blade method, a gravure method, a roll coater method, a spray method, a dip method, a bar method, a curtain method, a slot-die method, a slide die method, and an extrusion method, can be used as the method for forming each layer described above on the support. The individual coating compositions may be applied in such a manner that a first coating composition is applied and dried and then a second coating composition is applied and dried to form one layer after another, or the same coating composition may be applied separately to form two or more layers. Further, simultaneous multilayer coating may also be performed, in which individual coating compositions are applied all at once to form two or more layers simultaneously. In any stage after each layer is formed or after all layers are formed, the layer may be subjected to a smoothing treatment by a known method, such as supercalendering or soft calendering.

### EXAMPLES

The present invention is described in more detail with reference to Examples. However, the present invention is not limited to these Examples. In the Examples, “parts” and “i” represent “parts by mass” and “mass %” unless otherwise specified. The particle diameters, such as average particle diameters and maximum particle diameters, were measured with a SALD2200 laser diffraction particle diameter distribution analyzer (produced by Shimadzu Corporation). “Average particle diameter” as used herein refers to a median diameter (D50).

The hollow particles used in the Examples and Comparative Examples are as follows.
Hollow particles A: average particle diameter (D50): 5.0 μm; maximum particle diameter (D100): 13.5 μm; hollow ratio: 90%; proportion of particles having a particle diameter of 2 μm or less: 0.2 volume %; solids concentration: 15.0%
Hollow particles B: average particle diameter (D50): 11 μm; maximum particle diameter (D100): 23 μm; hollow ratio: 93%; proportion of particles having a particle diameter of 2 μm or less: 0 volume %; solids concentration: 15.0%
Hollow particles C: Ropaque SN-1055 (produced by Dow); average particle diameter (D50): 1.0 μm; maximum particle diameter (D100): 1.8 μm; hollow ratio: 55%; solids concentration: 26.5%. The average particle diameters (D50) and maximum particle diameters (D100) of these hollow particles were measured using a SALD2200 laser diffraction particle diameter analyzer (produced by Shimadzu Corporation) at a refractive index of 1.70-0.01i.

The latexes used in the Examples and Comparative Examples are as follows.
Latex A: styrene-butadiene copolymer latex development product (Tg: −35° C.; particle diameter: 300 nm; solids concentration: 48)
Latex B: styrene-butadiene copolymer latex development product (Tg: −10° C.; particle diameter: 190 nm; solids concentration: 48%)
Latex C: styrene-butadiene copolymer latex (trade name: L-1571, produced by Asahi Kasei Corporation; Tg: −3° C.; particle diameter: 190 nm; solids concentration: 48%)

### Example 1

### (1) Preparation of Coating Liquid for Undercoat Layer

A coating liquid for an undercoat layer was prepared by mixing and stirring 100 parts of hollow particles A, 38 parts of calcined kaolin (trade name: Ansilex 93, produced by BASF), 79.2 parts of latex A, 32 parts of a 25% aqueous solution of oxidized starch, 1.1 parts of carboxymethylcellulose (trade name: Cellogen AG gum, produced by DKS Co., Ltd.), and 100 parts of water.

### (2) Preparation of Leuco Dye Dispersion (Dispersion A)

40 parts of 3-di-(n-butyl)amino-6-methyl-7-anilinofluoran, 40 parts of a 10% aqueous solution of polyvinyl alcohol (degree of polymerization: 500, degree of saponification: 88), and 20 parts of water were mixed. The resulting mixture was pulverized with a sand mill (produced by Aimex Co., Ltd., a sand grinder) to an average particle diameter of 0.5 μm, thus obtaining a leuco dye dispersion (dispersion A).

### (3) Preparation of Developer Dispersion (Dispersion B)

40 parts of 4-hydroxy-4′-isopropoxy diphenyl sulfone, 40 parts of a 10% aqueous solution of polyvinyl alcohol (degree of polymerization: 500, degree of saponification: 88%), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion B).

### (4) Preparation of Developer Dispersion (Dispersion C)

40 parts of N,N′-di-[3-(p-toluenesulfonyl)oxy]phenylurea, 40 parts of a 10% aqueous solution of polyvinyl alcohol (degree of polymerization: 500, degree of saponification: 88%), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion C).

### (5) Preparation of Sensitizer Dispersion (Dispersion D)

40 parts of 1,2-di(3-methylphenoxy)ethane (trade name: KS-232, produced by Sankosha Co., Ltd.), 40 parts of a 10% aqueous solution of polyvinyl alcohol (degree of polymerization: 500, degree of saponification: 88), and 20 parts of water were mixed. The resulting mixture was pulverized with a sand mill (produced by Aimex Co., Ltd., a sand grinder) to an average particle diameter of 1.0 μm, thus obtaining a sensitizer dispersion (dispersion D).

### (6) Preparation of Coating Liquid for Heat-Sensitive Recording Layer

A coating liquid for a heat-sensitive recording layer was prepared by mixing and stirring 31.8 parts of leuco dye dispersion A, 63.6 parts of developer dispersion B, 15.9 parts of developer dispersion C, 22.7 parts of sensitizer dispersion D, 46.7 parts of a 15% aqueous solution of completely saponified polyvinyl alcohol (trade name: PVA110, degree of saponification: 99 mol %, average degree of polymerization: 1000, produced by Kuraray Co., Ltd.), 20.8 parts of a styrene-butadiene copolymer latex (trade name: L-1571, produced by Asahi Kasei Corp., solids concentration: 48%), 18 parts of aluminum hydroxide (trade name: Higilite H-42, produced by Showa Keikinzoku), 5 parts of adipic acid dihydrazide (produced by Otsuka Chemical Co., Ltd.), and 200 parts of water.

### (7) Preparation of Coating Liquid for Protective Layer

A coating liquid for a protective layer was prepared by mixing and stirring a composition containing 308 parts of a 12% aqueous solution of diacetone-modified polyvinyl alcohol (trade name: DF-10, produced by Japan Vam & Poval Co., Ltd.), 60 parts of kaolin (trade name: Hydragloss 90, produced by KaMin LLC), 5.6 parts of zinc stearate wax (trade name: Hidorin Z-8, produced by Chukyo Yushi Co., Ltd., solid concentration: 36%), and 150 parts of water.

### (8) Preparation of Heat-Sensitive Recording Material

The coating liquid for an undercoat layer, the coating liquid for a heat-sensitive recording layer, and the coating liquid for a protective layer were applied in amounts after drying of 4.5 g/m², 3.5 g/m², and 2.5 g/m², respectively, to one surface of high-quality paper having a basis weight of 60 g/m², and dried to form an undercoat layer, a heat-sensitive recording layer, and a protective layer in this order. The obtained product was then super-calendered to smooth the surface, thus obtaining a heat-sensitive recording material.

### Example 2

A heat-sensitive recording material was obtained in the same manner as in Example 1, except that in the preparation of the coating liquid for a heat-sensitive recording layer of Example 1, the amount of developer dispersion C was changed from 15.9 parts to 6.8 parts.

### Example 3

A heat-sensitive recording material was obtained in the same manner as in Example 1, except that in the preparation of the coating liquid for a heat-sensitive recording layer of Example 1, the amount of developer dispersion B was changed from 63.6 parts to 39.8 parts, and the amount of developer dispersion C was changed from 15.9 parts to 39.8 parts.

### Example 4

A heat-sensitive recording material was obtained in the same manner as in Example 1, except that in the preparation of the coating liquid for a heat-sensitive recording layer of Example 1, the amount of developer dispersion B was changed from 63.6 parts to 31.8 parts, and the amount of developer dispersion C was changed from 15.9 parts to 47.7 parts.

### Example 5

### (9) Preparation of Developer Dispersion (Dispersion E)

40 parts of 2,4′-dihydroxydiphenyl sulfone (trade name: 2,4′-BPS, produced by Nicca Chemical Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion E).

A heat-sensitive recording material was obtained in the same manner as in Example 1, except that in the preparation of the coating liquid for a heat-sensitive recording layer of Example 1, 63.6 parts of developer dispersion E was used in place of 63.6 parts of developer dispersion B.

### Example 6

### (10) Preparation of Developer Dispersion (Dispersion F)

40 parts of 4,4′-dihydroxydiphenyl sulfone (trade name: 4,4′-BPS, produced by Nicca Chemical Co., Ltd.), 40 parts of a 10% aqueous solution of polyvinyl alcohol (degree of polymerization: 500, degree of saponification: 88f), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion F).

A heat-sensitive recording material was obtained in the same manner as in Example 1, except that in the preparation of the coating liquid for a heat-sensitive recording layer of Example 1, 63.6 parts of developer dispersion F was used in place of 63.6 parts of developer dispersion B.

### Example 7

### (11) Preparation of Developer Dispersion (Dispersion G)

40 parts of bis(3-allyl-4-hydroxy)diphenyl sulfone (trade name: TG-SH, produced by Nippon Kayaku Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion G).

A heat-sensitive recording material was obtained in the same manner as in Example 1, except that in the preparation of the coating liquid for a heat-sensitive recording layer of Example 1, 63.6 parts of developer dispersion G was used in place of 63.6 parts of developer dispersion B.

### Example 8

### (12) Preparation of Developer Dispersion (Dispersion H)

40 parts of 4-hydroxyphenyl(4′-n-propoxyphenyl)sulfone (trade name: Tomirac KN, produced by Mitsubishi Chemical Corporation), 40 parts of a 10% aqueous solution of polyvinyl alcohol (degree of polymerization: 500, degree of saponification: 88%), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion H).

A heat-sensitive recording material was obtained in the same manner as in Example 1, except that in the preparation of the coating liquid for a heat-sensitive recording layer of Example 1, 63.6 parts of developer dispersion H was used in place of 63.6 parts of developer dispersion B.

### Example 9

### (13) Preparation of Developer Dispersion (Dispersion J)

40 parts of 4-hydroxy-4′-benzyloxydiphenyl sulfone (trade name: BPS-MBE, produced by Nicca Chemical Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion J).

A heat-sensitive recording material was obtained in the same manner as in Example 1, except that in the preparation of the coating liquid for a heat-sensitive recording layer of Example 1, 63.6 parts of developer dispersion J was used in place of 63.6 parts of developer dispersion B.

### Example 10

### (14) Preparation of Developer Dispersion (Dispersion K)

40 parts of 4-allyloxy-4′-hydroxydiphenyl sulfone (trade name: BPS-MAE, produced by Nicca Chemical Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion K).

A heat-sensitive recording material was obtained in the same manner as in Example 1, except that in the preparation of the coating liquid for a heat-sensitive recording layer of Example 1, 63.6 parts of developer dispersion K was used in place of 63.6 parts of developer dispersion B.

### Example 11

### (15) Preparation of Developer Dispersion (Dispersion L)

40 parts of N-p-tolylsulfonyl-N′-3-(p-tolylsulfonyloxy)phenylurea (trade name: PF201, produced by Solenis), 40 parts of a 105 aqueous solution of polyvinyl alcohol (degree of polymerization: 500, degree of saponification: 88%), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion L).

A heat-sensitive recording material was obtained in the same manner as in Example 1, except that in the preparation of the coating liquid for a heat-sensitive recording layer of Example 1, 63.6 parts of developer dispersion L was used in place of 63.6 parts of developer dispersion B.

### Example 12

### (16) Preparation of Developer Dispersion (Dispersion M)

40 parts of N-[2-(3-phenylureido)phenyl]benzenesulfonamide (trade name: NKK-1304, produced by Nippon Soda Co., Ltd.), 40 parts of a 10=t aqueous solution of polyvinyl alcohol (degree of polymerization: 500, degree of saponification: 88%), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion M).

A heat-sensitive recording material was obtained in the same manner as in Example 1, except that in the preparation of the coating liquid for a heat-sensitive recording layer of Example 1, 63.6 parts of developer dispersion M was used in place of 63.6 parts of developer dispersion B.

### Example 13

A heat-sensitive recording material was obtained in the same manner as in Example 12, except that in the preparation of the coating liquid for an undercoat layer of Example 12, the amount of hollow particles A was changed from 100 parts to 46.7 parts, the amount of calcined kaolin (trade name: Ansilex 93, produced by BASF) was changed from 38 parts to 46 parts, and the amount of water was changed from 100 parts to 145 parts.

### Example 14

A heat-sensitive recording material was obtained in the same manner as in Example 12, except that in the preparation of the coating liquid for an undercoat layer of Example 12, latex B was used in place of latex A.

### Example 15

A heat-sensitive recording material was obtained in the same manner as in Example 12, except that in the preparation of the coating liquid for an undercoat layer of Example 12, latex C was used in place of latex A.

### Example 16

A heat-sensitive recording material was obtained in the same manner as in Example 12, except that in the preparation of the coating liquid for an undercoat layer of Example 12, hollow particles B were used in place of hollow particles A.

### Example 17

A heat-sensitive recording material was obtained in the same manner as in Example 12, except that in the preparation of the coating liquid for an undercoat layer of Example 12, 56.6 parts of hollow particles C was used in place of 100 parts of hollow particles A, and the amount of water was changed from 100 parts to 175 parts.

### Example 18

### (17) Preparation of Developer Dispersion (Dispersion N)

40 parts of 5-(N-3-methylphenyl-sulfonamide)-N′,N″-bis-(3-methylphenyl)-isophthalic acid diamide (trade name: PF425, produced by Solenis), 40 parts of a 10% aqueous solution of polyvinyl alcohol (degree of polymerization: 500, degree of saponification: 88%), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion N).

A heat-sensitive recording material was obtained in the same manner as in Example 1, except that in the preparation of the coating liquid for a heat-sensitive recording layer of Example 1, 63.6 parts of developer dispersion N was used in place of 63.6 parts of developer dispersion B.

### Comparative Example 1

A heat-sensitive recording material was obtained in the same manner as in Example 1, except that in the preparation of the coating liquid for a heat-sensitive recording layer of Example 1, the amount of developer dispersion B was changed from 63.6 parts to 79.5 parts, and the amount of developer dispersion C was changed from 15.9 parts to 0 parts.

### Comparative Example 2

### (18) Preparation of Developer Dispersion (Dispersion 0)

40 parts of a diphenylsulfone derivative represented by the following formula (3) (trade name: D-90, produced by Nippon Soda Co., Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion 0).

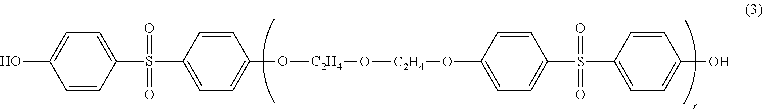

wherein r=1 to 6.

A heat-sensitive recording material was obtained in the same manner as in Example 1, except that in the preparation of the coating liquid for a heat-sensitive recording layer of Example 1, 15.9 parts of developer dispersion O was used in place of 15.9 parts of developer dispersion C.

### Comparative Example 3

### (19) Preparation of Developer Dispersion (Dispersion P)

40 parts of 4,4-bis(4-methyl-3-phenoxycarbonylaminophenylurea)diphenylsulfone (trade name: UU, produced by Chemipro Kasei Kaisha, Ltd.), 40 parts of a 10% aqueous solution of polyvinyl alcohol (degree of polymerization: 500, degree of saponification: 88%), and 20 parts of water were mixed. The resulting mixture was pulverized with a sand mill (produced by Aimex Co., Ltd., a sand grinder) to an average particle diameter of 1.0 μm, thus obtaining a developer dispersion (dispersion P).

A heat-sensitive recording material was obtained in the same manner as in Example 1, except that in the preparation of the coating liquid for a heat-sensitive recording layer of Example 1, 15.9 parts of developer dispersion P was used in place of 15.9 parts of developer dispersion C.

### Comparative Example 4

A heat-sensitive recording material was obtained in the same manner as in Example 10, except that in the preparation of the coating liquid for a heat-sensitive recording layer of Example 10, 15.9 parts of developer dispersion 0 was used in place of 15.9 parts of developer dispersion C.

### Comparative Example 5

A heat-sensitive recording material was obtained in the same manner as in Example 10, except that in the preparation of the coating liquid for a heat-sensitive recording layer of Example 10, 15.9 parts of developer dispersion P was used in place of 15.9 parts of developer dispersion C.

### Comparative Example 6

A heat-sensitive recording material was obtained in the same manner as in Example 11, except that in the preparation of the coating liquid for a heat-sensitive recording layer of Example 11, the amount of developer dispersion L was changed from 63.6 parts to 79.5 parts, and the amount of developer dispersion C was changed from 15.9 parts to 0 parts.

### Comparative Example 7

A heat-sensitive recording material was obtained in the same manner as in Example 11, except that in the preparation of the coating liquid for a heat-sensitive recording layer of Example 11, 15.9 parts of developer dispersion O was used in place of 15.9 parts of developer dispersion C.

### Comparative Example 8

A heat-sensitive recording material l was obtained in the same manner as in Example 11, except that in the preparation of the coating liquid for a heat-sensitive recording layer of Example 11, 15.9 parts of developer dispersion P was used in place of 15.9 parts of developer dispersion C.

### Comparative Example 9

A heat-sensitive recording material was obtained in the same manner as in Example 12, except that in the preparation of the coating liquid for a heat-sensitive recording layer of Example 12, the amount of developer dispersion M was changed from 63.6 parts to 79.5 parts, and the amount of developer dispersion C was changed from 15.9 parts to 0 parts.

### Comparative Example 10

A heat-sensitive recording material was obtained in the same manner as in Example 12, except that in the preparation of the coating liquid for a heat-sensitive recording layer of Example 12, 15.9 parts of developer dispersion O was used in place of 15.9 parts of developer dispersion C.

### Comparative Example 11

A heat-sensitive recording material was obtained in the same manner as in Example 12, except that in the preparation of the coating liquid for a heat-sensitive recording layer of Example 12, 15.9 parts of developer dispersion P was used in place of 15.9 parts of developer dispersion C.

The Examples and Comparative Examples were evaluated according to the following methods. Table 1 shows the results.

### Recording Density

An image was recorded on each heat-sensitive recording material at applied energies of 0.17 mJ/dot (medium energy color density) and 0.25 mJ/dot (maximum color density) using a thermal recording tester (trade name: TH-PMD, produced by Ohkura Electric Co., Ltd.). The printed portion was measured with a spectrodensitometer (X-Rite 504, produced by X-Rite). A larger value indicates a denser print.
The evaluation criteria for medium energy color density were the following.
A color density of 1.00 or more: compatible with high-speed printing, very good
A color density of 0.80 or more and less than 1.00: needed for practical use
A color density of less than 0.80: low sensitivity with many defects such as white spots, problematic in practical use
The evaluation criteria for maximum color density were the following.
A color density of 1.40 or more: very good
A color density of 1.20 or more and less than 1.40: needed for practical use
A color density of less than 1.20: low printing density, undesirable for practical use

### Water Resistance

A sample of each heat-sensitive recording material that had been subjected to color development using a label printer (trade name: L-2000, produced by Ishida Co., Ltd.) was immersed in water for 24 hours. After this treatment, the optical density of the recorded portion was measured with a spectrodensitometer (X-Rite 504, produced by X-Rite). Further, the remaining percentage of the recorded portion was determined according to the following equation.

Remaining percentage (%)=(recording density after treatment/recording density before treatment)×100
The evaluation criteria were the following.
A remaining percentage of 80% or more: good
A remaining percentage of 60% or more and less than 80%: no practical problem
A remaining percentage of less than 60%: the recording density after treatment is low, which is problematic in practical use

### Water Plasticizer Resistance

A wrap film (trade name: Hi-S Soft, produced by Nippon Carbide Industries Co., Inc.) was wound around a polycarbonate pipe (diameter: 40 mm) three times, and a sample prepared by immersing a heat-sensitive recording material that had been subjected to color development using a label printer (trade name: L-2000, produced by Ishida Co., Ltd.) in water for 5 seconds was placed on the film. The wrap film was further wound around the sample three times, and the sample was allowed to stand at 40° C. for 24 hours. After this treatment, the optical density of the recorded portion was measured with a spectrodensitometer (X-Rite 504, produced by X-Rite). Further, the remaining percentage of the recorded portion was determined according to the following equation.

Remaining percentage (%)=(recording density after treatment/recording density before treatment)×100
The evaluation criteria were the following.
A remaining percentage of 803 or more: good
A remaining percentage of 60% or more and less than 80%: no practical problem
A remaining percentage of less than 60%: the recording density after treatment is low, which is problematic in practical use

### Alcohol Resistance

A sample of each heat-sensitive recording material that had been subjected to color development using a label printer (trade name: L-2000, produced by Ishida Co., Ltd.) was immersed in a 75 volume % ethanol aqueous solution for 10 minutes. After this treatment, the optical density of the blank-paper portion and the optical density of the recorded portion were measured with a spectrodensitometer (X-Rite 504, produced by X-Rite). Further, the remaining percentage of the recorded portion was determined according to the following equation.

Remaining percentage (%)=(recording density after treatment/recording density before treatment)×100
The evaluation criteria were the following.
A density of the blank-paper portion of less than 0.10: good
A density of the blank-paper portion of 0.10 or more and less than 0.20: fogging is somewhat observed, but no practical problem
A density of the blank-paper portion of 0.20 or more: strong fogging, which is problematic in practical use
A remaining percentage of 80% or more: good
A remaining percentage of 60%, or more and less than 80%: no practical problem
A remaining percentage of less than 60%: the recording density after treatment is low, which is problematic in practical use

TABLE 1

| | Undercoat Layer | | | | | Heat-sensitive Recording Layer | | |
|---|---|---|---|---|---|---|---|---|
| | | Latex | | | | | | Amount per |
| | Pigment | Tg | | Hollow Particles | | First | Second | Part of First |
| | (Mass %) | (° C.) | (Mass %) | Kind | (Mass %) | Developer | Developer | Developer |
| Ex. 1 | 38 | −35 | 38 | A | 15 | D-8 | S-176 | 0.25 |
| Ex. 2 | 38 | −35 | 38 | A | 15 | D-8 | ↑ | 0.11 |
| Ex. 3 | 38 | −35 | 38 | A | 15 | D-8 | ↑ | 1 |
| Ex. 4 | 46 | −35 | 38 | A | 15 | D-8 | ↑ | 1.5 |
| Ex. 5 | 38 | −35 | 38 | A | 15 | 2,4′-BPS | ↑ | 0.25 |
| Ex. 6 | 38 | −35 | 38 | A | 15 | 4,4′-BPS | ↑ | 0.25 |
| Ex. 7 | 38 | −35 | 38 | A | 15 | TG-SH | ↑ | 0.25 |
| Ex. 8 | 38 | −35 | 38 | A | 15 | Tomirac KN | ↑ | 0.25 |
| Ex. 9 | 38 | −10 | 38 | A | 15 | BPS-MBE | ↑ | 0.25 |
| Ex. 10 | 38 | −35 | 38 | A | 15 | BPS-MAE | ↑ | 0.25 |
| Ex. 11 | 38 | −35 | 38 | A | 15 | PF201 | ↑ | 0.25 |
| Ex. 12 | 38 | −35 | 38 | A | 15 | NKK-1304 | ↑ | 0.25 |
| Ex. 13 | 38 | −35 | 38 | A | 7 | NKK-1304 | ↑ | 0.25 |
| Ex. 14 | 38 | −10 | 38 | A | 15 | NKK-1304 | ↑ | 0.25 |
| Ex. 15 | 38 | −3 | 38 | A | 15 | NKK-1304 | ↑ | 0.25 |
| Ex. 16 | 38 | −35 | 38 | B | 15 | NKK-1304 | ↑ | 0.25 |
| Ex. 17 | 66 | −3 | 10 | C | 15 | NKK-1304 | ↑ | 0.25 |
| Ex. 18 | 38 | −35 | 38 | A | 15 | PF-425 | ↑ | 0.25 |
| Comp. Ex. 1 | 38 | −35 | 38 | A | 15 | D-8 | — | 0 |
| Comp. Ex. 2 | 38 | −35 | 38 | A | 15 | D-8 | D-90 | 0.25 |
| Comp. Ex. 3 | 38 | −35 | 38 | A | 15 | D-8 | UU | 0.25 |
| Comp. Ex. 4 | 38 | −35 | 38 | A | 15 | BPS-MAE | D-90 | 0.25 |
| Comp. Ex. 5 | 38 | −35 | 38 | A | 15 | BPS-MAE | UU | 0.25 |
| Comp. Ex. 6 | 38 | −35 | 38 | A | 15 | PF201 | — | 0 |
| Comp. Ex. 7 | 38 | −35 | 38 | A | 15 | PF201 | D-90 | 0.25 |
| Comp. Ex. 8 | 38 | −35 | 38 | A | 15 | PF201 | UU | 0.25 |
| Comp. Ex. 9 | 38 | −35 | 38 | A | 15 | NKK-1304 | — | 0 |
| Comp. Ex. 10 | 38 | −35 | 38 | A | 15 | NKK-1304 | D-90 | 0.25 |
| Comp. Ex. 11 | 38 | −35 | 38 | A | 15 | NKK-1304 | UU | 0.25 |

| | | | Preservation Test | | | | |
|---|---|---|---|---|---|---|---|
| | | | | | | Alcohol Resistance | |
| | | | | | Water | (Immersion for 10 Min) | |
| | | | | Water | Plasticizer | | Recorded |
| | | | | Resistance | Resistance | | Portion |
| | Color Density | | | Remaining | Remaining | Background | Remaining |
| | 0.17 | 0.25 | Untreated | Percentage | Percentage | Portion | Percentage |
| | (mJ/dot) | (mJ/dot) | Density | (%) | (%) | Density | (%) |
| Ex. 1 | 1.03 | 1.48 | 1.45 | 73 | 67 | 0.06 | 66 |
| Ex. 2 | 1.05 | 1.50 | 1.48 | 67 | 62 | 0.06 | 62 |
| Ex. 3 | 1.01 | 1.50 | 1.48 | 81 | 78 | 0.06 | 72 |
| Ex. 4 | 0.95 | 1.51 | 1.48 | 93 | 91 | 0.06 | 81 |
| Ex. 5 | 0.81 | 1.46 | 1.44 | 65 | 63 | 0.06 | 64 |
| Ex. 6 | 0.84 | 1.47 | 1.44 | 66 | 62 | 0.06 | 63 |
| Ex. 7 | 1.10 | 1.52 | 1.50 | 69 | 67 | 0.06 | 67 |
| Ex. 8 | 0.93 | 1.48 | 1.45 | 69 | 67 | 0.06 | 68 |
| Ex. 9 | 0.98 | 1.43 | 1.41 | 65 | 68 | 0.06 | 66 |
| Ex. 10 | 1.09 | 1.45 | 1.44 | 66 | 71 | 0.06 | 66 |
| Ex. 11 | 0.89 | 1.38 | 1.36 | 94 | 96 | 0.08 | 87 |
| Ex. 12 | 0.88 | 1.35 | 1.33 | 92 | 94 | 0.07 | 84 |
| Ex. 13 | 0.82 | 1.35 | 1.33 | 92 | 95 | 0.07 | 84 |
| Ex. 14 | 0.85 | 1.34 | 1.33 | 92 | 95 | 0.07 | 82 |
| Ex. 15 | 0.83 | 1.36 | 1.34 | 91 | 94 | 0.07 | 82 |
| Ex. 16 | 0.83 | 1.31 | 1.30 | 92 | 96 | 0.07 | 83 |
| Ex. 17 | 0.65 | 1.28 | 1.26 | 91 | 92 | 0.06 | 75 |
| Ex. 18 | 0.82 | 1.33 | 1.31 | 95 | 96 | 0.06 | 88 |
| Comp. Ex. 1 | 1.05 | 1.49 | 1.47 | 45 | 35 | 0.06 | 32 |
| Comp. Ex. 2 | 1.03 | 1.45 | 1.44 | 51 | 37 | 0.06 | 35 |
| Comp. Ex. 3 | 1.02 | 1.46 | 1.44 | 62 | 48 | 0.22 | 55 |
| Comp. Ex. 4 | 1.03 | 1.41 | 1.38 | 45 | 35 | 0.06 | 34 |
| Comp. Ex. 5 | 1.02 | 1.40 | 1.38 | 51 | 42 | 0.23 | 54 |
| Comp. Ex. 6 | 0.89 | 1.35 | 1.32 | 51 | 50 | 0.08 | 55 |
| Comp. Ex. 7 | 0.85 | 1.33 | 1.31 | 50 | 52 | 0.08 | 56 |
| Comp. Ex. 8 | 0.85 | 1.32 | 1.31 | 65 | 63 | 0.25 | 68 |
| Comp. Ex. 9 | 0.87 | 1.32 | 1.32 | 54 | 57 | 0.07 | 45 |
| Comp. Ex. 10 | 0.86 | 1.32 | 1.31 | 55 | 57 | 0.08 | 46 |
| Comp. Ex. 11 | 0.86 | 1.31 | 1.31 | 68 | 68 | 0.24 | 55 |

As can be seen from Table 1, the heat-sensitive recording materials of Examples 1 to 18 were excellent in water resistance, water plasticizer resistance, and alcohol resistance. In contrast, as a stability improver, D-90 was insufficient, and UU caused fogging in the blank-paper portion in terms of alcohol resistance.

1: A heat-sensitive recording material comprising at least an undercoat layer and a heat-sensitive recording layer in this order on a support,
the undercoat layer containing an inorganic pigment, hollow particles, and a binder,
the heat-sensitive recording layer containing a leuco dye, developers, and a binder,
the heat-sensitive recording layer containing a first developer and a second developer as the developers, and
the heat-sensitive recording layer containing an N,N′-diarylurea-based compound represented by formula (1) as the second developer: 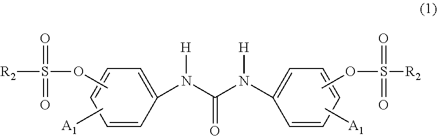
R₂ represents a C₁₋₁₂ alkyl group, a C₇₋₁₂ aralkyl group, or a C₆₋₁₂ aryl group, the aralkyl group and aryl group may be substituted with a C₁₋₁₂ alkyl group, a C₁₋₁₂ alkoxy group, a C₆₋₁₂ aryl group, or a halogen atom, and a plurality of R₂s may be the same or different; and
A₁ represents a hydrogen atom or a C₁₋₄ alkyl group, and a plurality of A₁s may be the same or different.

2: The heat-sensitive recording material according to claim 1, wherein the N,N′-diarylurea-based compound represented by formula (1) is at least one member selected from the group consisting of N,N′-di-[3-(p-toluenesulfonyloxy)phenyl]urea, N,N′-di-[3-(o-toluenesulfonyloxy)phenyl]urea, N,N′-di-[3-(benzenesulfonyloxy)phenyl]urea, N,N′-di-[3-(mesitylenesulfonyloxy)phenyl]urea, N,N′-di-[3-(4-ethylbenzenesulfonyloxy)phenyl]urea, N,N′-di-[3-(2-naphthalenesulfonyloxy)phenyl]urea, N,N′-di-[3-(p-methoxybenzenesulfonyloxy)phenyl]urea, N,N′-di-[3-(benzylsulfonyloxy)phenyl]urea, N,N′-di-[3-(ethanesulfonyloxy)phenyl]urea, N,N′-di-[3-(p-toluenesulfonyloxy)-4-methyl-phenyl]urea, N,N′-di-[4-(p-toluenesulfonyloxy)phenyl]urea, N,N′-di-[4-(benzenesulfonyloxy)phenyl]urea, N,N′-di-[4-(ethanesulfonyloxy)phenyl]urea, and N,N′-di-[2-(p-toluenesulfonyloxy)]phenylurea.

3: The heat-sensitive recording material according to claim 1, wherein the N,N′-diarylurea-based compound represented by formula (1) is N,N′-di-[3-(p-toluenesulfonyl)oxy]phenylurea.

4: The heat-sensitive recording material according to claim 1, wherein a diphenylsulfone derivative represented by formula (2) is contained as the first developer: 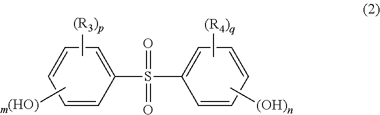
wherein
R₃ and R₄ are the same or different, and each represents C₁₋₄ alkyl group, a C₂₋₄ alkenyl group, a C₁₋₄ alkoxy group, a C₂₋₄ alkenyloxy group, a C₇₋₁₂ aralkyloxy group, or a halogen atom;
m is an integer of 0 to 2;
n is an integer of 1 to 3; and
p and q are the same or different, and each represents an integer of 0 to 2.

5: The heat-sensitive recording material according to claim 4, wherein the diphenylsulfone derivative represented by formula (2) is at least one member selected from the group consisting of 4-hydroxy-4′-isopropoxy diphenyl sulfone, 4,4′-dihydroxydiphenyl sulfone, 2,4′-dihydroxydiphenyl sulfone, bis(3-allyl-4-hydroxy)diphenyl sulfone, 4-hydroxyphenyl(4′-n-propoxyphenyl)sulfone, 4-allyloxy-4′-hydroxydiphenyl sulfone, and 4-hydroxy-4′-benzyloxydiphenyl sulfone.

6: The heat-sensitive recording material according to claim 1, wherein the first developer is N-p-tolylsulfonyl-N′-3-(p-tolylsulfonyloxy)phenylurea.

7: The heat-sensitive recording material according to claim 1, wherein the first developer is N-[2-(3-phenylureido)phenyl]benzenesulfonamide.

8: The heat-sensitive recording material according to claim 1, wherein the first developer is 5-(N-3-methylphenyl-sulfonamide)-N′,N″-bis-(3-methylphenyl)-isophthalic acid diamide.

9: The heat-sensitive recording material according to claim 1, wherein the second developer is contained in an amount of 0.1 to 3 parts by mass per part by mass of the first developer.

10: The heat-sensitive recording material according to claim 1, wherein the second developer is contained in an amount of 0.1 to 1 part by mass per part by mass of the first developer.

11: The heat-sensitive recording material according to claim 1, wherein
the hollow particles have a maximum particle diameter (D100) of 10 to 30 μm and an average particle diameter (D50) of 4.0 to 15 μm,
the ratio of the maximum particle diameter (D100) to the average particle diameter (D50), which is D100/D50, is 1.8 to 3.0, and
the volume % of hollow particles with a particle diameter of 2.0 μm or less is 1% or less.

12: The heat-sensitive recording material according to claim 1, wherein the hollow particles have a hollow ratio of 80 to 98%.

13: The heat-sensitive recording material according to claim 1, wherein the binder in the undercoat layer contains a binder resin with a glass transition temperature of −10° C. or lower.

14: The heat-sensitive recording material according to claim 1, wherein the binder in the undercoat layer contains a binder resin with a glass transition temperature of −30° C. or lower.

15: The heat-sensitive recording material according to claim 1, comprising an adhesive layer on at least one surface of the support.
